(19) United States
(12) Patent Application Publication
(10) Pub. No.: US 2005/0114874 A1
(43) Pub. Date: May 26, 2005

(54) [AUXILIARY CONTROL BUTTON STRUCTURE FOR CD PLAYER OR THE LIKE]

(75) Inventor: Wei-Jia Hsieh, TAIPEI (TW)

Correspondence Address: VISION ELECTRONICS CO., LTD., 2F-4, NO. 148, SEC. 4, CHUNG HSIAO EAST ROAD, TAIPEI, TW

(73) Assignee: SOLETK COMPUTER INC., HSICHIH CITY, TAIPEI HSIEN (TW)

(21) Appl. No.: 10/709,762

(22) Filed: May 26, 2004

(30) Foreign Application Priority Data
Nov. 26, 2003 (TW) 092133246

(51) Int. Cl. G11B 33/02

(52) U.S. Cl. 720/646

(57) ABSTRACT

An auxiliary control button structure installed in the face panel of a CD/VCD/DVD player for controlling the operation of the control button of the CD/VCD/DVD player is disclosed to have two mounting portions fixedly fastened to the face panel, an adjustment ment unit provided between the mounting portions and adjustable to fit the position of the control button of the CD/VCD/DVD player, two spring members respectively connected between the mounting portions and two opposite lateral sides of the adjustment unit, and a press member formed integral with lateral side of the adjustment unit for pressing by the user to force the adjustment unit against the control button of the CD/VCD/DVD player.

### CROSS REFERENCE TO RELATED APPLICATIONS

This application claims the priority benefit of Taiwan patent application number 092133246 filed on Nov. 26, 2003.

### BACKGROUND OF INVENTION

1. Field of the Invention

The present invention relates to an auxiliary control button structure for use in a CD/VCD/DVD player for controlling the operation of the control button of the CD/VCD/DVD player and more particularly, to such an auxiliary control button structure, which is adjustable to fit any of a variety of CD/VCD/DVD players.

2. Description of the Related Art

Following fast development of electronic technology, a variety of CD/VCD/DVD players have been disclosed, and have appeared on the market. A CD/VCD/DVD player has a control button protruded over the front side of the face panel for operation by the user to eject the loaded disk. The face panel has a button hole adapted to accommodate the control button. A face panel for one particular model of CD/VCD/DVD player may not fit another model of CD/VCD/DVD player. Therefore, different face panels shall be made to fit different models of CD/VCD/DVD players. In order to eliminate this problem, an auxiliary control button structure may be used with a face panel to fit any of a variety of CD/VCD/DVD players. A conventional design comprises a mainframe face panel, which has a disk insertion slot, a through hole near the disk insertion slot, two sliding grooves at two sides of the through hole, and two locating portions respectively provided at one end of each groove, a movable operation member, which comprises a flat base movably coupled to the sliding grooves and a stem perpendicularly extended from the flat base and inserted through the through hole of the mainframe face panel, and a spring member sleeved onto the stem and supported between the flat base of the movable operation member and the mainframe face panel. Upon insertion of a disk through the disk insertion slot into the CD/VCD/DVD player, the button of the CD/VCD/DVD player is forced outwards to move the stem of the movable operation member out of the front side of the mainframe face panel. When the user pressed the stem of the movable operation member with the finger, the button of the CD/VCD/DVD player is forced inwards to eject the disk out of the CD/VCD/DVD player and the disk insertion slot of the mainframe face panel. However, this structure of mainframe face panel indirect switch button still has numerous drawbacks as outlined hereinafter.

1. Because the locations of the disk insertion slot and the movable operation member at the mainframe face panel are not changeable, the disk insertion slot and the movable operation member must be respectively accurately aimed at the disk access hole and the button of the CD/VCD/DVD player.

2. Because the locations of the disk insertion slot and the movable operation member at the mainframe face panel are not changeable, the mainframe face panel becomes useless if the disk insertion slot and the movable operation member cannot be respectively accurately aimed at the disk access hole and the button of a particular model of CD/VCD/DVD player.

3. Because the spring member is sleeved onto the stem and supported between the flat base of the movable operation member and the mainframe face panel, it wears quickly with use.

### SUMMARY OF INVENTION

The present invention has been accomplished under the circumstances in view. It is therefore the main object of the present invention to provide an auxiliary control button structure that eliminates the aforesaid drawbacks. According to one aspect of the present invention, the auxiliary control button structure is installed in the face panel of a CD/VCD/DVD player for controlling the operation of the control button of the CD/VCD/DVD player, comprising two mounting portions fixedly fastened to the face panel, an adjustment unit provided between the mounting portions and adjustable to fit the position of the control button of the CD/VCD/DVD player, two spring members respectively connected between the mounting portions and two opposite lateral sides of the adjustment unit, and a press member formed integral with lateral side of the adjustment unit for pressing by the user to force the adjustment unit against the control button of the CD/VCD/DVD player. According to another aspect of the present invention, the adjustment unit comprises a base, two sliding slots arranged in parallel at two sides of the base, and a slide mounted in said sliding slots and moved to stop against the control button of the CD/VCD/DVD player. According to still another aspect of the present invention, the spring members are detoured spring bars.

### BRIEF DESCRIPTION OF DRAWINGS

FIG. 1 is an elevational view of an auxiliary control button structure according to the present invention.

FIG. 2 is an exploded view of the auxiliary control button structure according to the present invention.

FIG. 3 is another exploded view of the present invention when viewed from another angle.

FIG. 4 is a side view of the auxiliary control button structure according to the present invention.

FIG. 5 is a sectional view showing the auxiliary control button structure installed in the face panel of a CD player.

FIG. 6 is a front view of FIG. 5.

FIG. 7 is a top view in section of FIG. 5.

FIG. 8 is an enlarged view of part A of FIG. 7.

FIG. 9 is similar to FIG. 8 but showing the press member of the auxiliary control button structure pressed.

### DETAILED DESCRIPTION

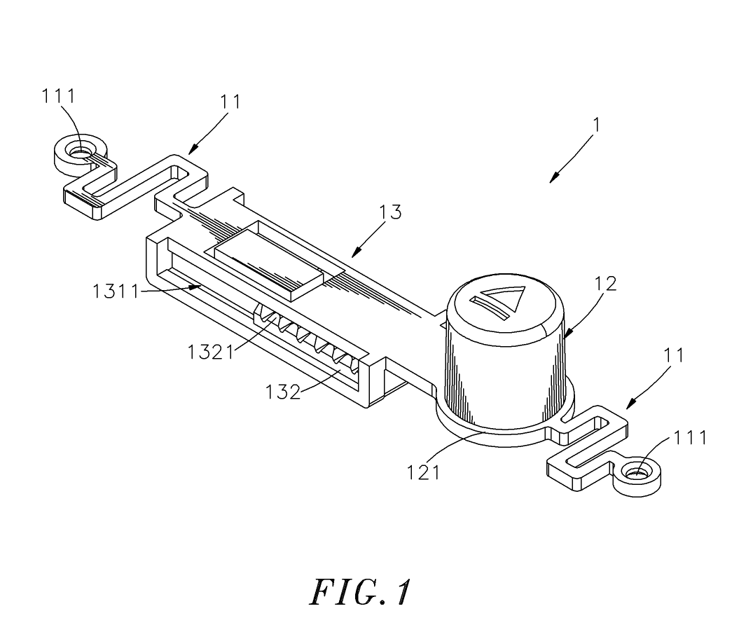

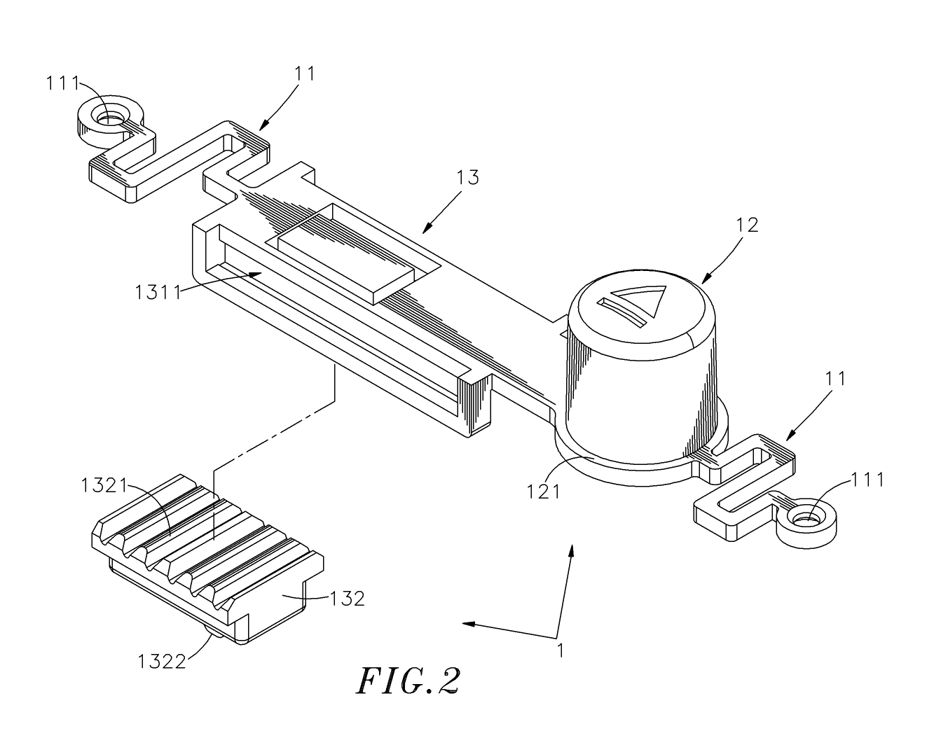

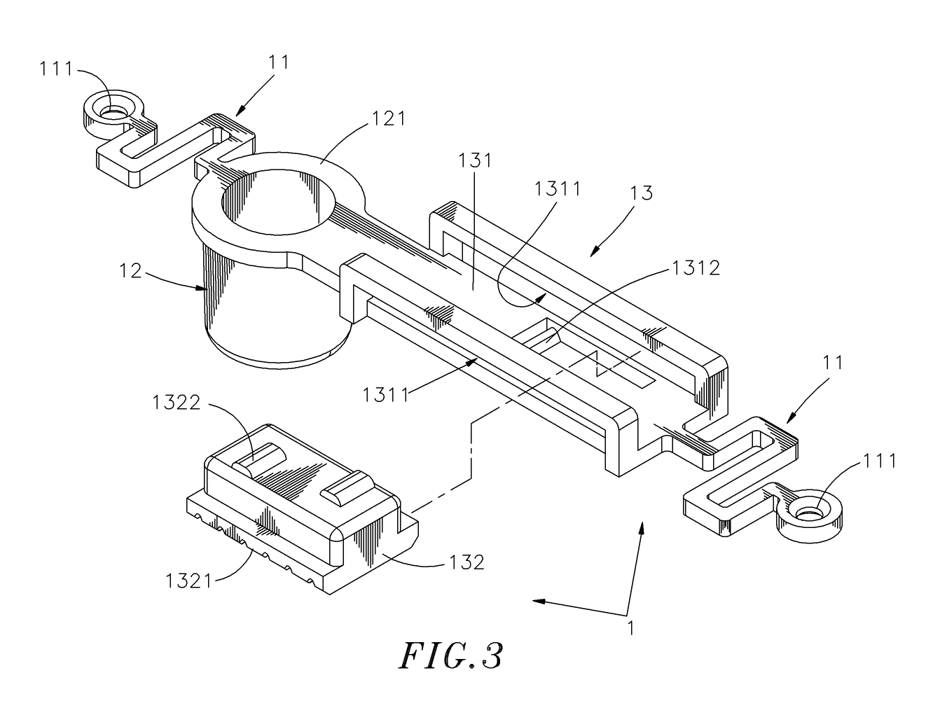

Referring to FIGS. 1˜3, an auxiliary control button structure 1 is shown comprising two mounting portions 111 disposed at two sides, an adjustment unit 13 provided between the mounting portions 111, two spring members 11 respectively connected between the mounting portions 111 and two opposite lateral sides of the adjustment unit 13, and a press member 12 provided between one side of the adjustment unit 13 and one spring member 11. The spring members 11 are detoured spring bars. The mounting portions 111 are shaped like an eyelet. The press member 12 has a bottom wall 121 formed integral with lateral side of the adjustment unit 13. The adjustment unit 13 comprises a base 131, two sliding slots 1311 arranged in parallel at two sides of the base 131 and extending in direction from the press member 12 toward one spring member 11, and a slide 132 axially slidably mounted in the sliding slots 1311. When imparting a push force to the slide 132 to move the slide 132 along the sliding slots 1311, the spring members 11 are deformed elastically.

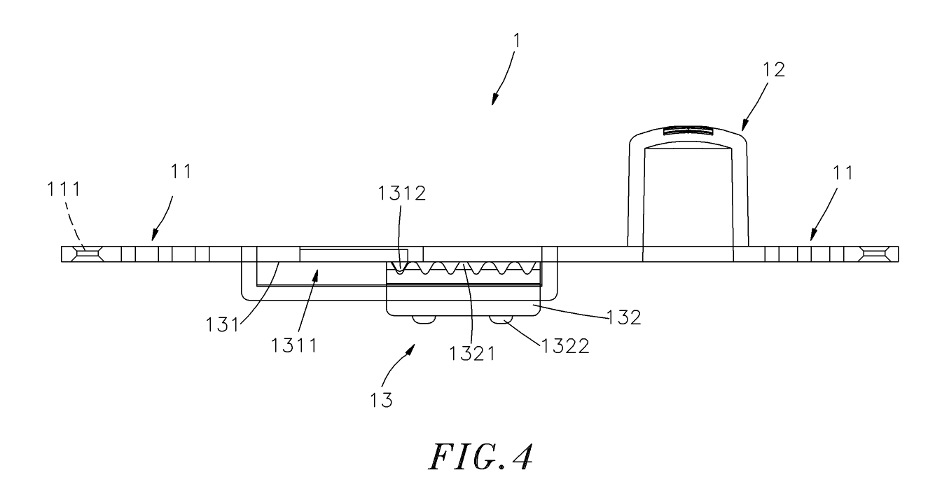

The aforesaid adjustment unit 13 further comprises a stop member 1312 in the base 131. The slide 132 comprises a serrated engagement portion 1321 at the top and two stop members 1322 at the bottom. After installation of the slide 132 in the sliding slots 1311, the stop member 1312 engages the serrated engagement portion 1321 to hold the slide 132 in position (see FIG. 4).

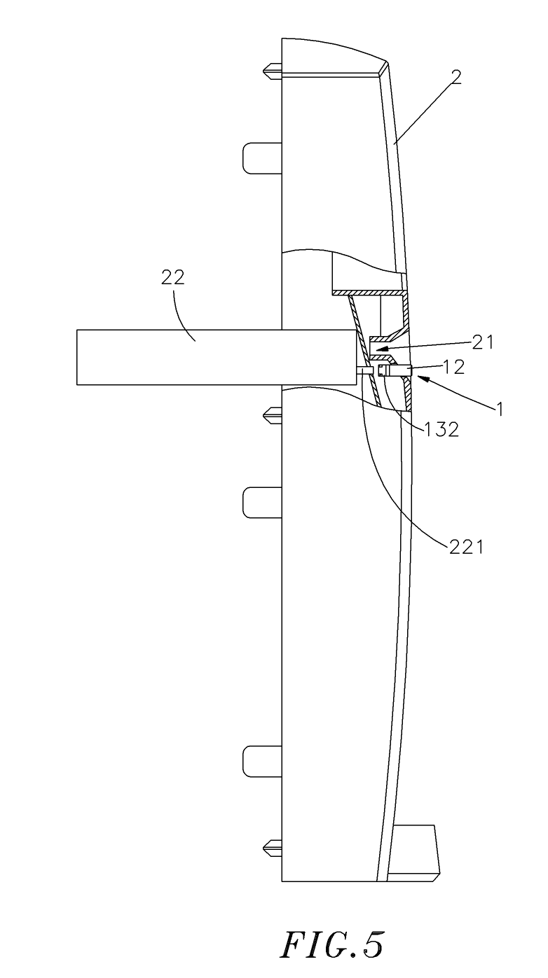

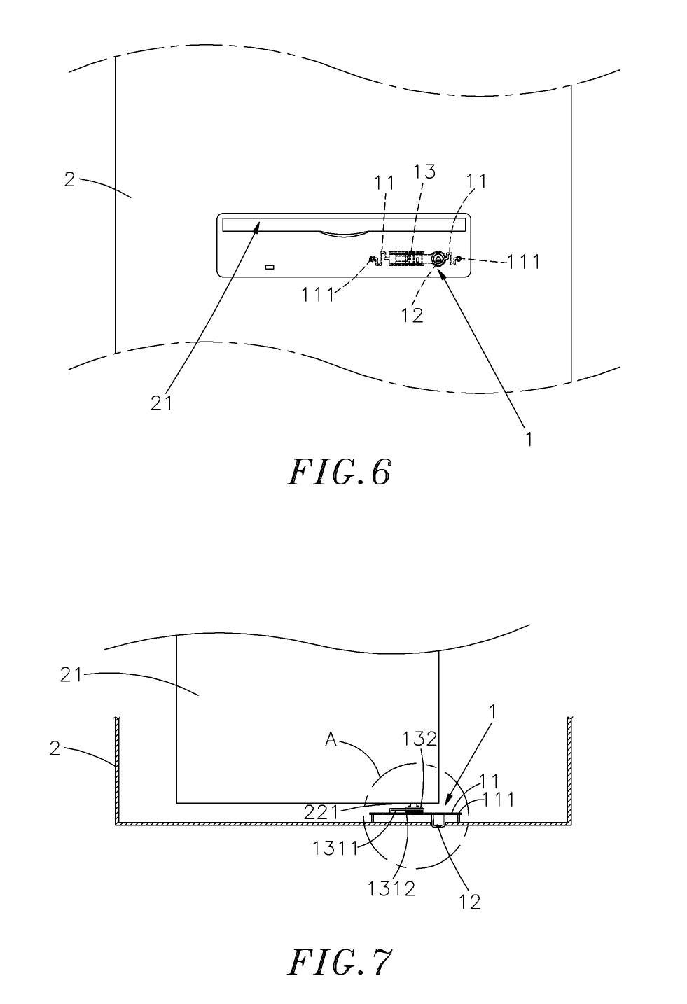

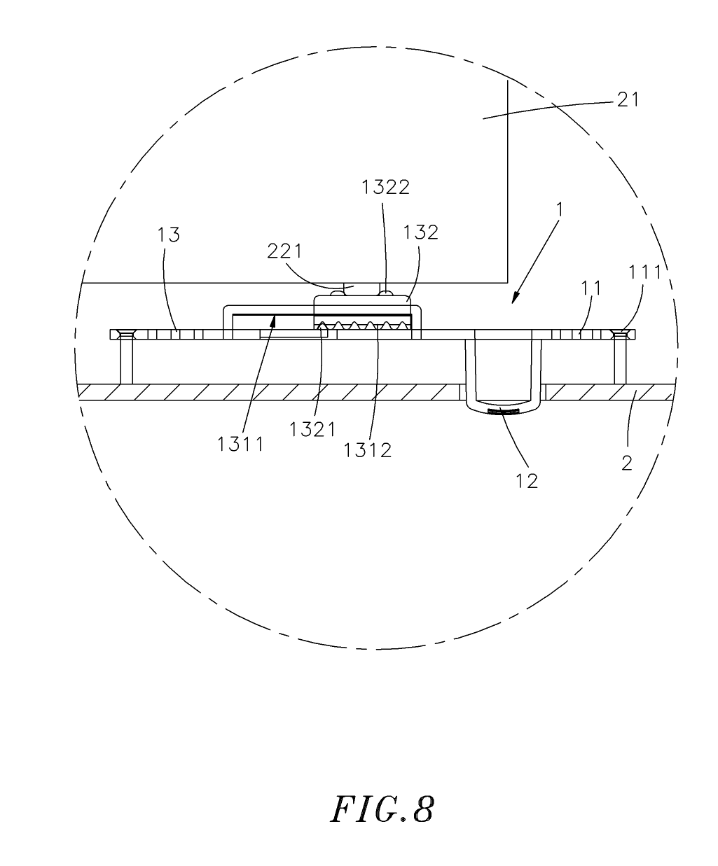

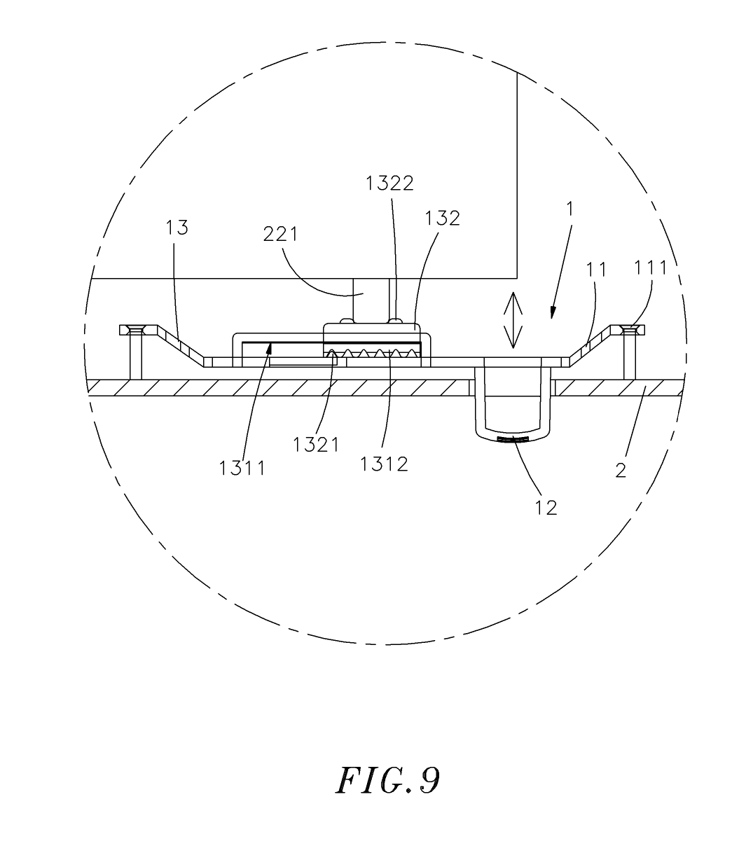

Referring to FIGS. 5˜7, the auxiliary control button structure 1 is mounted in an opening 21 in a face panel 2 with the mounting portions 111 fixedly fastened to the inside wall of the face panel 2 by fastening devices (screws, rivets, heat sealing, etc.), keeping the adjustment unit 13 aimed at the control button 221 of the CD (VCD/DVD) player 22. After installation, move the slide 132 along the sliding slots 1311 to the position where the stop members 1322 of the slide 132 are pressed on the control button 221 of the CD (VCD/DVD) player 22. When inserted a disk into the CD (VCD/DVD) player 22, the control button 221 of the CD (VCD/DVD) player 22 is pushed outwards to the extended position to move the slide 132, thereby the press member 12 to make a short distance displacement toward the outside of the face panel 2 (see FIG. 8) and the spring members 11 produce the elastic deformation in small range. By means of the aforesaid arrangement, the auxiliary CD player control button structure fits the face panel 2 of a computer or CD/VCD/DVD player.

Referring to FIG. 8˜9 and FIG. 7 again, after insertion of a disk into the CD (VCD/DVD) player 22, the control button 221 of the CD (VCD/DVD) player 22 is pushed outwards to force the press member 12 toward the outside of the face panel 2 (see FIG. 8). When pressed the press member 12, the slide 132 of the adjustment unit 13 forces the control button 221 inwards, thereby ejecting the disk out of the CD (VCD/DVD) player 22. Because the slide 132 moves in the sliding slots 1311 within a limited distance during inward/outward displacement of the control button 221 of the CD (VCD/DVD) player 22, the amount of elastic deformation of the spring members 11 is limited, preventing loosening or disconnection of the auxiliary control button structure 1 from the face panel 2.

As indicated above, the auxiliary CD player control button structure of the present invention achieves the following advantages.

1. The slide of the auxiliary control button structure can be moved along the sliding slots to fit the position of the control button of any of a variety of CD/VCD/DVD player.

2. The press member of the auxiliary control button structure makes only a short distance displacement during inward/outward displacement of the control button of the CD/VCD/DVD player, and therefore the limited elastic deformation of the spring members does not cause loosening or disconnection of the auxiliary control button structure from the face panel.

3. After installation of the auxiliary control button structure in the face panel of a CD/VCD/DVD player, the slide can be adjusted to fit the control button of the CD/VCD/DVD player, therefore the manufacturing of the face panel is simplified, saving much manufacturing cost.

4. The detoured design of the spring members of the auxiliary control button structure extends the service life of the spring members.

5. The adjustable unit of the auxiliary control button structure fits any of a variety of CD/VCD/DVD players.

A prototype of auxiliary control button structure has been constructed with the features of FIGS. 1˜9. The auxiliary control button structure functions smoothly to provide all of the features discussed earlier.

Although a particular embodiment of the invention has been described in detail for purposes of illustration, various modifications and enhancements may be made without departing from the spirit and scope of the invention. Accordingly, the invention is not to be limited except as by the appended claims.

1. An auxiliary control button structure installed in the face panel of a CD/VCD/DVD player for controlling the operation of the control button of said CD/VCD/DVD player, the auxiliary control button structure comprising two mounting portions fixedly fastened to said face panel, an adjustment unit provided between said mounting portions, said adjustment unit being adjustable to fit the position of the control button of said CD/VCD/DVD player, two spring members respectively connected between said mounting portions and two opposite lateral sides of said adjustment unit, and a press member provided between one side of said adjustment unit and one said spring member for pressing by the user to force said adjustment unit against the control button of said CD/VCDDVD player.

2. The auxiliary control button structure as claimed in claim 1, wherein said adjustment unit comprises a base, two sliding slots arranged in parallel at two sides of said base, and a slide mounted in said sliding slots and moved to stop against the control button of said CD/VCD/DVD player.

3. The auxiliary control button structure as claimed in claim 1, wherein said adjustment unit comprises a stop member formed in said base and adapted to stop said slide in position.

4. The auxiliary control button structure as claimed in claim 3, wherein said slide has a serrated engagement portion forced into engagement with the stop member in the base of said adjustment unit.

5. The auxiliary control button structure as claimed in claim 1, wherein said spring members are detoured spring bars.

6. The auxiliary control button structure as claimed in claim 1, wherein said mounting portions are respectively formed of an eyelet.
